(19) United States
(12) Patent Application Publication
(10) Pub. No.: US 2025/0382174 A1
(43) Pub. Date: Dec. 18, 2025

(54) METHOD FOR PRODUCING HIGH-PURITY PHOSPHORIC ACID THROUGH QUANTUM BEHAVIOR CONTROL

(71) Applicant: RAM TECHNOLOGY CO., LTD., Yongin-si (KR)

(72) Inventors: June Ing KIL, Seoul (KR); Jeong Jun Park, Seoul (KR); Young Su jang, Hwaseong-si (KR); Min Kyu Choi, Yongin-si (KR); Ji Hyeon Park, Yongin-si (KR); Ji Hoon Heo, Pajupsi (KR)

(73) Assignee: RAM TECHNOLOGY CO., LTD., Yongin-si (KR)

(21) Appl. No.: 19/240,042

(22) Filed: Jun. 17, 2025

(30) Foreign Application Priority Data
Jun. 17, 2024 (KR) 10-2024-0078188

(51) Int. Cl. C01B 25/234

(52) U.S. Cl. CPC C01B 25/234; C01P 2006/80

(57) ABSTRACT

The present disclosure relates to a method for producing high-purity phosphoric acid through a quantum behavior control, and more particularly, to a method for producing high-purity phosphoric acid capable of obtaining high-purity phosphoric acid from low-grade phosphoric acid economically and industrially by obtaining phosphoric acid crystals by, using a temperature difference between an introduced phosphoric acid raw material and a cooling device, controlling crystal growth position and rate of the phosphoric acid crystals through changes in the molecular or quantum behaviors of phosphoric acid, water molecules and impurities in the phosphoric acid raw material to suppress a phenomenon of impurities being trapped inside the phosphoric acid crystals, and melting some of the formed phosphoric acid crystals through additionally introducing a high-temperature phosphoric acid raw material to remove the impurities trapped inside the crystals.

### TECHNICAL FIELD

The present disclosure relates to a method for producing high-purity phosphoric acid through a quantum behavior control, and more particularly, to a method for producing high-purity phosphoric acid capable of obtaining high-purity phosphoric acid from low-grade phosphoric acid economically and industrially by obtaining phosphoric acid crystals by, using a temperature difference between an introduced phosphoric acid raw material and a cooling device, controlling crystal growth position and rate of the phosphoric acid crystals through changes in the molecular or quantum behaviors of phosphoric acid, water molecules and impurities in the phosphoric acid raw material to suppress a phenomenon of impurities being trapped inside the phosphoric acid crystals, and melting some of the formed phosphoric acid crystals through additionally introducing a high-temperature phosphoric acid raw material to remove the impurities trapped inside the crystals.

### BACKGROUND ART

Phosphoric acid is an essential chemical material in a semiconductor manufacturing process as an only substance capable of wet-etching a semiconductor silicon nitride film (Si₃N₄, SiN). In such a silicon nitride film etching process, impurities in the phosphoric acid etchant directly affect semiconductor yield and defect occurrences, and therefore, the concentration is strictly controlled.

Since high-purity phosphoric acid usable in such a semiconductor manufacturing process may only be produced through a dry method of extracting yellow phosphorous (P4) from high-quality phosphorite and oxidizing and burning the yellow phosphorous at a high temperature of 200° C. or higher, a lot of process cost is required.

In addition, due to the limited reserves of high-quality phosphorite, depletion of the mineral is accelerated, and this causes a problem of continuously increasing the price of high-purity phosphoric acid, leading to an economical problem of increasing a semiconductor manufacturing cost.

As an existing method for purifying phosphoric acid containing a large amount of metal ion impurities, various methods such as a film separation method, an ion exchange method or a liquid extraction method have been proposed.

First, the film separation method has advantages of high yield and purity of collected phosphoric acid, but has disadvantages of high film separation process cost and very complicated operation method. In addition, there may be a safety issue for the used film due to the corrosiveness of phosphoric acid.

The ion exchange method uses an ion exchange resin or calcium zeolite to remove an acid, and since the ion exchange resin used herein has low ion exchange capacity, only an acid with low concentration may be treated, and since the ion exchange resin after completing ion exchange needs to be continuously replaced, there is a limit of incurring continuous process cost.

The liquid extraction method has advantages in that the process may be continuously operated and the devices are inexpensive, but has a disadvantage in that high-purity phosphoric acid at a level required for a semiconductor process is not able to be obtained.

A crystallization method is a method of forming crystals from a saturated solution by controlling nucleation and crystal growth rates of crystals.

The crystallization method may be divided into a method of crystallization using a phosphoric acid seed for facilitating nucleation of crystals, and a method of crystallization not using a phosphoric acid seed. When a phosphoric acid seed is not used, the crystallization condition needs to be controlled to a temperature of 40° C. below zero or lower to proceed with crystallization, causing a problem of requiring a lot of cost and time to form crystals.

Accordingly, there is a demand for the development of a new method for producing phosphoric acid capable of obtaining high-purity phosphoric acid that does not include unnecessary metals economically and industrially by separating impurities from a phosphoric acid raw material containing a lot of impurities.

### DISCLOSURE

### Technical Problem

The present disclosure is directed to providing a method for producing high-purity phosphoric acid through a quantum behavior control capable of obtaining phosphoric acid economically and industrially.

The present disclosure relates to a method for producing high-purity phosphoric acid capable of obtaining high-purity phosphoric acid from low-grade phosphoric acid economically and industrially by obtaining phosphoric acid crystals by, using a temperature difference between an introduced phosphoric acid raw material and a cooling device, controlling crystal growth position and rate of the phosphoric acid crystals through changes in the molecular or quantum behaviors of phosphoric acid, water molecules and impurities in the phosphoric acid raw material to suppress a phenomenon of impurities being trapped inside the phosphoric acid crystals, and melting some of the formed phosphoric acid crystals through additionally introducing a high-temperature phosphoric acid raw material to remove the impurities trapped inside the crystals.

### Technical Solution

One embodiment of the present disclosure provides a method for producing high- purity phosphoric acid, the method including the steps of: supplying a phosphoric acid raw material containing impurities to a cooling device (S1); introducing a phosphoric acid seed to the cooling device (S2); forming phosphoric acid crystals by stirring the introduced phosphoric acid raw material and the phosphoric acid seed (S3); and additionally introducing a phosphoric acid raw material containing impurities to the cooling device (S4), wherein temperatures of the phosphoric acid raw materials introduced in steps (S1) and (S4) are higher than a temperature of the cooling device by 5° C. to 35° C.

The temperatures of the phosphoric acid raw materials introduced in steps (S1) and (S4) may be from 30° C. to 50° C.

The temperature of the cooling device in step (S1) may be from 15° C. to 30° C.

The step of additionally introducing a phosphoric acid raw material (S4) may be performed one or more times.

In the step of additionally introducing a phosphoric acid raw material (S4), a content of the additionally introduced phosphoric acid raw material may be 10 parts by weight to 90 parts by weight based on 100 parts by weight of a total content of the phosphoric acid raw material.

The method for producing high-purity phosphoric acid of the present disclosure may further include, after the step of additionally introducing a phosphoric acid raw material (S4), growing phosphoric acid crystals while cooling the cooling device to 0° C. to 15° C. (S5).

In the step of growing phosphoric acid crystals (S5), a cooling rate of the cooling device may be from 0.1° C./min to 5° C./min.

The method for producing high-purity phosphoric acid of the present disclosure may further include, after the step of growing phosphoric acid crystals (S5), partially melting some of the crystallized phosphoric acid by raising the temperature of the cooling device to 20° C. to 35° C. (S6).

The method for producing high-purity phosphoric acid of the present disclosure may further include, after separating the partially melted phosphoric acid, obtaining phosphoric acid crystals not melted in the partially melting step (S6) by raising the temperature of the cooling device to 40° C. or higher (S7).

A stirring rate in the step of forming phosphoric acid crystals (S3) may be from 50 rpm to 600 rpm.

The phosphoric acid raw material may have a concentration of 80% to 91.6%.

In the phosphoric acid raw material, a total content of the impurities including Al, K and Cu may be 300 ppb or greater.

The phosphoric acid obtained using the above-described method may include Al, K and Cu each in an amount of 1 ppb or less.

### Advantageous Effects

High-purity phosphoric acid may be produced economically and industrially when using a method for producing high-purity phosphoric acid through a quantum behavior control provided in the present disclosure.

### Best Mode

Unless defined otherwise in the present specification, all technical terms and scientific terms have the same meaning as meanings commonly understood by those skilled in the art. Terms used for the description in the present disclosure are only to effectively describe specific embodiments and are not intended to limit the present disclosure.

Singular forms used in the present specification include plural forms as well, unless the context clearly indicates otherwise.

The term ‘include’ used in the present specification specifies specific features, areas, integers, steps, operations, elements and/or components, and does not exclude the presence or addition of other specific features, areas, integers, steps, operations, elements, components and/or groups.

The present disclosure may have various modifications applied thereto, and may have various forms, and specific embodiments will be illustrated and described in detail below. However, this is not intended to limit the present disclosure to specific disclosed forms, and needs to be construed as including all modifications, equivalents and substitutes included in the idea and the technical scope.

In the present specification, when a positional relationship between two parts is described as, for example, ‘˜on’, ‘˜in an upper portion of’, ‘˜in a lower portion of’, ‘˜next to’ and the like, one or more other parts may be located between the two parts unless an expression such as ‘right’ or ‘directly’ is used.

In the present specification, when a temporal relationship is described as, for example, ‘˜after’, ‘˜subsequent to’, ‘˜then’, ‘˜prior to’ and the like, cases that where operations are not continuous may also be included unless an expression such as ‘immediately’ or ‘directly’ is used.

In the present specification, the term ‘at least one’ needs to be construed as including all combinations presentable from one or more related items.

Hereinafter, a method for producing high-purity phosphoric acid according to specific embodiments of the present disclosure will be described in more detail.

According to one embodiment of the present disclosure, there is provided a method for producing high-purity phosphoric acid, the method including the steps of: supplying a phosphoric acid raw material containing impurities to a cooling device (S1); introducing a phosphoric acid seed to the cooling device (S2); forming phosphoric acid crystals by stirring the introduced phosphoric acid raw material and the phosphoric acid seed (S3); and additionally introducing a phosphoric acid raw material containing impurities to the cooling device (S4), wherein temperatures of the phosphoric acid raw materials introduced in the steps (S1) and (S4) are higher than a temperature of the cooling device by 5° C. to 35° C.

As described above, a method of crystallization through cooling is well known in the related art as a method for purifying phosphoric acid, however, when a phosphoric acid seed is not used, the crystallization condition needs to be controlled to a temperature of 40° C. below zero or lower to proceed with crystallization, causing a problem of requiring a lot of cost and time to form crystals.

Accordingly, the inventors of the present disclosure have studied a method for further increasing purification efficiency while performing crystallization at room temperature using a phosphoric acid seed, and as a result, have identified that high-purity phosphoric acid may be obtained on an economical and industrial scale by increasing purification efficiency through obtaining phosphoric acid crystals by, using a temperature difference between an introduced phosphoric acid raw material and a cooling device, controlling crystal growth position and rate of the phosphoric acid crystals through changes in the molecular or quantum behaviors of phosphoric acid, water molecules and impurities in the phosphoric acid raw material to suppress a phenomenon of impurities being trapped inside the phosphoric acid crystals, and melting some of the formed phosphoric acid crystals through additionally introducing a high-temperature phosphoric acid raw material to remove the impurities trapped inside the crystals, and have completed the present disclosure.

According to the present disclosure, phosphoric acid with higher purity may be obtained by improving impurity purification efficiency when the method includes the steps of: supplying a phosphoric acid raw material containing impurities to a cooling device (S1); introducing a phosphoric acid seed to the cooling device (S2); forming phosphoric acid crystals by stirring the introduced phosphoric acid raw material and the phosphoric acid seed (S3); and additionally introducing a phosphoric acid raw material containing impurities to the cooling device (S4), and temperatures of the phosphoric acid raw materials introduced in the steps (S1) and (S4) are higher than a temperature of the cooling device by 5° C. to 35° C.

First, as the phosphoric acid raw material, commercially available low-purity (industrial-grade) phosphoric acid may be purchased and used, or phosphoric acid used in a semiconductor cleaning process may be collected and used. However, in terms of resource recycling, it is preferred to collect and use impurity-containing phosphoric acid used in a semiconductor process.

In the method for producing high-purity phosphoric acid of the present disclosure, a phosphoric acid raw material containing a large amount of impurities is supplied to a cooling device, a phosphoric acid seed is introduced to the cooling device, and then the introduced phosphoric acid raw material and the phosphoric acid seed are stirred to form phosphoric acid crystals, and herein, impurity purification efficiency may increase through a temperature difference between the phosphoric acid raw material and the cooling device.

Specifically, by providing a temperature difference between the introduced phosphoric acid raw material and the cooling device, changes in the molecular and quantum behaviors of phosphoric acid, water molecules and impurities in the phosphoric acid raw material prevent the crystals from being sporadically and rapidly formed, and a trap phenomenon of metal impurities being trapped inside the phosphoric acid crystals may be prevented, improving metal impurity purification efficiency.

When there is no or insignificant temperature change between the phosphoric acid raw material and the cooling device during the formation of phosphoric acid crystals by introducing a phosphoric acid seed, phosphoric acid crystallization occurs sporadically and rapidly, and a large amount of impurities are included in the formed phosphoric acid crystals due to the trap phenomenon of impurities being trapped inside the phosphoric acid crystals, reducing purity of the phosphoric acid obtained from crystallization.

In comparison, when a temperature difference between the phosphoric acid raw material and the cooling device is controlled to a certain level or higher and crystallization is performed by introducing a phosphoric acid seed, phosphoric acid crystal growth position and rate are controlled through changes in the molecular or quantum behaviors of phosphoric acid, water molecules and impurities in the phosphoric acid raw material, preventing phosphoric acid crystals from being sporadically formed, and a trap phenomenon of metal impurities being trapped inside the phosphoric acid crystals is prevented, increasing purification efficiency, and as a result, high-purity phosphoric acid may be obtained.

The temperature difference between the phosphoric acid raw material and the cooling device may be 5° C. or greater. When the phosphoric acid raw material and the cooling device have a temperature difference of less than 5° C., phosphoric acid crystals are formed sporadically and rapidly, causing a problem of reducing the purification effect due to a trapping phenomenon of metal impurities being trapped inside the phosphoric acid crystals.

In addition, the temperature difference between the phosphoric acid raw material and the cooling device may be 35° C. or less. When the phosphoric acid raw material and the cooling device have a temperature difference of greater than 35° C., there may be a problem in that phosphoric acid crystals do not grow sufficiently.

Specifically, the temperatures of the phosphoric acid raw materials containing impurities introduced in the steps (S1) and (S4) may be from 30° C. to 50° C., and the temperature of the cooling device when introducing the phosphoric acid raw materials may be from 15° C. to 30° C.

According to the present disclosure, after supplying a phosphoric acid raw material containing impurities to a cooling device (S1), a phosphoric acid seed is introduced to the cooling device (S2), and herein, the phosphoric acid seed may be introduced in an amount of 0.01 parts by weight to 10 parts by weight based on 100 parts by weight of the phosphoric acid raw material.

When the introduced amount of the phosphoric acid seed is too small, there may be a problem in that the rate of phosphoric acid crystallization is slow or crystals do not grow, and when the introduced amount of the phosphoric acid seed is too large, phosphoric acid crystals may be formed sporadically, and therefore, it is preferred to introduce the phosphoric acid seed in the above-described amount.

According to the present disclosure, after introducing a phosphoric acid seed to the cooling device (S2), the introduced phosphoric acid raw material and the phosphoric acid seed may be stirred to form phosphoric acid crystals (S3).

The stirring rate in the step of forming phosphoric acid crystals (S3) may be from 50 rpm to 600 rpm.

By stirring the phosphoric acid raw material and the phosphoric acid seed at a certain rate or higher in the step of forming phosphoric acid crystals (S3), a phenomenon of impurities being trapped in the phosphoric acid crystals may be suppressed, increasing the purification effect.

When the stirring rate is less than 50 rpm, purification efficiency is reduced since the phenomenon of impurities being trapped in the phosphoric acid crystals may not be suppressed, and when the stirring rate is greater than 600 rpm, there may be a problem in that partially melted phosphoric acid crystals do not grow sufficiently or disappear when introducing heated phosphoric acid due to the excessive fast stirring, resulting in a decrease in the yield of pure phosphoric acid crystals.

According to the present disclosure, the method may further include, after forming phosphoric acid crystals by stirring the introduced phosphoric acid raw material and the phosphoric acid seed (S3), additionally introducing a phosphoric acid raw material containing impurities to the cooling device (S4).

First, the initially introduced phosphoric acid raw material is brought into contact with the phosphoric acid seed to form phosphoric acid crystals. After that, crystallization proceeds while the phosphoric acid crystals grow, and during the crystallization process, pure phosphoric acid with almost no impurities is included inside the crystal, and the amount of impurities increases towards the crystal surface.

Herein, when a phosphoric acid raw material containing impurities is additionally introduced to the cooling device, impurities present on the crystallized surface may be melted and removed by the additionally introduced high-temperature phosphoric acid raw material, and the crystal growth rate increases by the added phosphoric acid raw material, obtaining phosphoric acid with higher purity.

For example, when the phosphoric acid crystals obtained from the initially introduced phosphoric acid raw material are referred to as primary phosphoric acid crystals, and when additionally introducing a phosphoric acid raw material containing impurities to the cooling device afterword, the surfaces of the first-formed primary phosphoric acid crystals are partially melted by the additionally introduced high-temperature phosphoric acid raw material, and impurities included in the surface are melted together and removed, obtaining phosphoric acid with higher purity.

The step of additionally introducing a phosphoric acid raw material (S4) may be performed regardless of time and frequency after forming phosphoric acid crystals by introducing and then stirring the phosphoric acid raw material and the phosphoric acid seed to the cooling device, that is, after the step (S3), before the step of growing phosphoric acid crystals of cooling the cooling device to 0° C. to 15° C. (S5).

Specifically, the step of additionally introducing a phosphoric acid raw material (S4) may be performed one or more times, may be performed immediately after the step of forming phosphoric acid crystals (S3) or after a predetermined time passes therefrom, may also be performed two or more times consecutively, or may also be performed once, and then additionally performed after a certain period of time.

The content of the phosphoric acid raw material additionally introduced in the step (S4) may be from 10 parts by weight to 90 parts by weight based on 100 parts by weight of the total content of the phosphoric acid raw material introduced in the method for producing high-purity phosphoric acid.

For example, when the content of the initially introduced phosphoric acid raw material is 20 parts by weight, the remaining 80 parts by weight of the phosphoric acid raw material may be additionally introduced in one or more installments in the step of additional introduction, and the frequency of additional introduction and the amount of introduction for each introduction are not limited.

According to the present disclosure, the method may further include, after the step of additionally introducing a phosphoric acid raw material (S4), growing phosphoric acid crystals while cooling the cooling device to 0° C. to 15° C. (S5).

In the step of growing phosphoric acid crystals (S5), the cooling rate of the cooling device may be from 0.1° C./min to 5° C./min, and cooling at the above-mentioned rate is suitable for removing impurities from the phosphoric acid raw material and obtaining high-purity phosphoric acid.

The method for producing high-purity phosphoric acid of the present disclosure may further include, after the step of growing phosphoric acid crystals (S5), partially melting some of the crystallized phosphoric acid by raising the temperature of the cooling device to 20° C. to 35° C. (S6).

As described above, crystallized phosphoric acid having grown by the crystallization process includes pure phosphoric acid with almost no impurities inside the crystal, and has the amount of impurities increasing towards the crystal surface.

Accordingly, by raising the temperature of the cooling device to 20° C. to 35° C. to partially melt some of the phosphoric acid crystal surface after the phosphoric acid crystals sufficiently grow, impurities attached to the surface may be removed, and phosphoric acid with higher purity may be obtained.

After that, the partially melted phosphoric acid is separated, and then phosphoric acid crystals not melted in the partially melting step (S6) may be obtained by raising the temperature of the cooling device to 40° C. or higher (S7).

The phosphoric acid raw material before the purification includes a large amount of impurities, and specifically, the total content of impurities including Al, K and Cu may be 300 ppb or greater in the phosphoric acid raw material.

As described above, high-purity phosphoric acid may be obtained economically and industrially using the method for producing high-purity phosphoric acid of the present disclosure, and specifically, the phosphoric acid obtained using the method may include Al, K and Cu each in an amount of 1 ppb or less.

Hereinafter, embodiments of the present disclosure will be described in more detail with reference to the following examples. However, the following examples are just for illustrating embodiments of the present disclosure, and the present disclosure is not limited by the following examples.

### (1) Example 1

A 91.6% phosphoric acid raw material (200 g) including impurities and heated to 30° C. was supplied to a cooling device of which temperature is set to 15° C.

A phosphoric acid seed (1 g) was introduced to the cooling device, and the result was stirred at 50 rpm to proceed with phosphoric acid crystallization.

After performing the crystallization process for 5 minutes, a 91.6% phosphoric acid raw material (100 g) including impurities and heated to 30° C. was additionally introduced thereto.

After 1 minute, a process of additionally introducing a 91.6% phosphoric acid raw material (100 g) including impurities and heated to 30° C. was repeated 7 times to introduce a total of 1000 g of the phosphoric acid raw material (introduced 7 times at intervals of 1 minute).

After that, the cooling device was cooled to 5° C. at a cooling rate of 0.1° C./min to grow phosphoric acid crystals.

Phosphoric acid that was not crystallized was removed, and then some of the crystallized phosphoric acid was partially melted and separated by raising the temperature of the cooling device to 20° C.

The remaining phosphoric acid crystals not melted were all melted by raising the temperature of the cooling device to 40° C. or higher, and finally purified crystallized phosphoric acid (794 g) was obtained.

### (2) Example 2

Crystallized phosphoric acid (650 g) was obtained in the same manner as in Example 1, except that the concentration of the phosphoric acid raw material used was changed to 80%.

### (3) Example 3

Crystallized phosphoric acid (726 g) was obtained in the same manner as in Example 1, except that the stirring rate was changed from 50 rpm to 600 rpm.

### (4) Example 4

A 91.6% phosphoric acid raw material (200 g) including impurities and heated to 30° C. was supplied to a cooling device set at 15° C.

A phosphoric acid seed (1 g) was introduced to the cooling device, and the result was stirred at 50 rpm to proceed with phosphoric acid crystallization.

After performing the crystallization process for 5 minutes, a 91.6% phosphoric acid raw material (100 g) including impurities and heated to 30° C. was additionally introduced thereto.

After 10 minutes, a process of additionally introducing a 91.6% phosphoric acid raw material (100 g) including impurities and heated to 30° C. was repeated 7 times to introduce a total of 1000 g of the phosphoric acid raw material (introduced 7 times at intervals of 10 minutes).

After that, the cooling device was cooled to 5° C. at a cooling rate of 0.1° C./min to grow phosphoric acid crystals.

Phosphoric acid that was not crystallized was removed, and then some of the crystallized phosphoric acid was partially melted and separated by raising the temperature of the cooling device to 20° C.

The remaining phosphoric acid crystals not melted were all melted by raising the temperature of the cooling device to 40° C. or higher, and finally purified crystallized phosphoric acid (837 g) was obtained.

### (5) Example 5

Crystallized phosphoric acid (801 g) was obtained in the same manner as in Example 1, except that the cooling rate of the cooling device was changed from 0.1° C./min to 5° C./min.

### (6) Example 6

Crystallized phosphoric acid (688 g) was obtained in the same manner as in Example 1, except that the cooling temperature of the cooling device was changed from 5° C. to 10° C.

### (7) Example 7

Crystallized phosphoric acid (713 g) was obtained in the same manner as in Example 1, except that a phosphoric acid raw material heated to 50° C. was used instead of the phosphoric acid raw material heated to 30° C.

### (8) Comparative Example 1

Phosphoric acid crystallization was performed in the same manner as in Example 1, except that a phosphoric acid raw material heated to 70° C. was used instead of the phosphoric acid raw material heated to 30° C., however, as a result of performing the crystallization, the phosphoric acid raw material was not crystallized.

### (9) Comparative Example 2

Phosphoric acid crystallization was performed in the same manner as in Example 1, except that a cooling device set at 30° C. was used instead of the cooling device set at 15° C., however, as a result of performing the crystallization, the phosphoric acid raw material was not crystallized.

### Analysis on Metal Impurity Content in Crystallized Phosphoric Acid

For each of the phosphoric acid raw material, the non-crystallized phosphoric acid, the phosphoric acid partially melted and separated, and the crystallized phosphoric acid obtained by raising the temperature to 40° C. or higher, the content of metal impurities in the phosphoric acid was analyzed using ICP-MS.

Specifically, the non-crystallized phosphoric acid, the partially melted phosphoric acid, and the crystallized phosphoric acid were each diluted with DIW or 3% nitric acid using Agilent ICP-MS 8900 to analyze the metal impurity content in the sample.

TABLE 1

| | | Example 1 | | Example 2 | | Example 3 | |
|---|---|---|---|---|---|---|---|
| | | Non- | | Non- | | Non- | |
| | | crystallized + | | crystallized + | | crystallized + | |
| | | Partially | | Partially | | Partially | |
| | Phosphoric | Melted | Crystallized | Melted | Crystallized | Melted | Crystallized |
| | Acid Raw | Phosphoric | Phosphoric | Phosphoric | Phosphoric | Phosphoric | Phosphoric |
| | Material | Acid | Acid | Acid | Acid | Acid | Acid |
| Al(ppb) | 184 | 694 | 0.54 | 397 | 0.61 | 596 | 0.47 |
| K(ppb) | 256 | 811 | 0.61 | 544 | 0.65 | 794 | 0.68 |
| Cu(ppb) | 312 | 1231 | 0.48 | 712 | 0.51 | 1003 | 0.41 |

TABLE 2

| | | Example 4 | | Example 5 | | Example 6 | |
|---|---|---|---|---|---|---|---|
| | | Non- | | Non- | | Non- | |
| | | crystallized + | | crystallized + | | crystallized + | |
| | | Partially | | Partially | | Partially | |
| | Phosphoric | Melted | Crystallized | Melted | Crystallized | Melted | Crystallized |
| | Acid Raw | Phosphoric | Phosphoric | Phosphoric | Phosphoric | Phosphoric | Phosphoric |
| | Material | Acid | Acid | Acid | Acid | Acid | Acid |
| Al(ppb) | 184 | 799 | 0.63 | 701 | 0.65 | 457 | 0.51 |
| K(ppb) | 256 | 1160 | 0.73 | 891 | 0.77 | 663 | 0.67 |
| Cu(ppb) | 312 | 1354 | 0.55 | 1255 | 0.64 | 901 | 0.77 |

TABLE 3

| | | Example 7 | | Comparative Example 1 | | Comparative Example 2 | |
|---|---|---|---|---|---|---|---|
| | | Non- | | Non- | | Non- | |
| | | crystallized + | | crystallized + | | crystallized + | |
| | | Partially | | Partially | | Partially | |
| | Phosphoric | Melted | Crystallized | Melted | Crystallized | Melted | Crystallized |
| | Acid Raw | Phosphoric | Phosphoric | Phosphoric | Phosphoric | Phosphoric | Phosphoric |
| | Material | Acid | Acid | Acid | Acid | Acid | Acid |
| Al(ppb) | 184 | 495 | 0.50 | 179 | — | 180 | — |
| K(ppb) | 256 | 614 | 0.74 | 258 | — | 254 | — |
| Cu(ppb) | 312 | 961 | 0.49 | 311 | — | 294 | — |

From Tables 1 to 3, it was identified that the phosphoric acid obtained using the preparation method of the present disclosure had a significantly reduced metal content in the phosphoric acid compared to the phosphoric acid raw material, and high-purity phosphoric acid was able to be obtained.

1. A method for producing high-purity phosphoric acid, the method comprising the steps of:
supplying a phosphoric acid raw material containing impurities to a cooling device (S1);
introducing a phosphoric acid seed to the cooling device (S2);
forming phosphoric acid crystals by stirring the introduced phosphoric acid raw material and the phosphoric acid seed (S3); and
additionally introducing a phosphoric acid raw material containing impurities to the cooling device (S4),
wherein temperatures of the phosphoric acid raw materials introduced in steps (S1) and (S4) are higher than a temperature of the cooling device by 5° C. to 35° C.

2. The method of claim 1, wherein the temperatures of the phosphoric acid raw materials introduced in steps (S1) and (S4) are from 30° C. to 50° C.

3. The method of claim 1, wherein the temperature of the cooling device in step (S1) is from 15° C. to 30° C.

4. The method of claim 1, wherein the step of additionally introducing a phosphoric acid raw material (S4) is performed one or more times.

5. The method of claim 1, wherein, in the step of additionally introducing a phosphoric acid raw material (S4), a content of the additionally introduced phosphoric acid raw material is from 10 parts by weight to 90 parts by weight based on 100 parts by weight of a total content of the phosphoric acid raw material.

6. The method of claim 1, further comprising, after the step of additionally introducing a phosphoric acid raw material (S4), growing phosphoric acid crystals while cooling the cooling device to 0° C. to 15° C. (S5).

7. The method of claim 6, wherein a cooling rate of the cooling device in the step of growing phosphoric acid crystals (S5) is from 0.1° C./min to 5° C./min.

8. The method of claim 6, further comprising, after the step of growing phosphoric acid crystals (S5), partially melting some of the crystallized phosphoric acid by raising the temperature of the cooling device to 20° C. to 35° C. (S6).

9. The method of claim 8, further comprising, after separating the partially melted phosphoric acid, obtaining phosphoric acid crystals not melted in the partially melting step (S6) by raising the temperature of the cooling device to 40° C. or higher (S7).

10. The method of claim 1, wherein a stirring rate in the step of forming phosphoric acid crystals (S3) is from 50 rpm to 600 rpm.

11. The method of claim 1, wherein the phosphoric acid raw material has a concentration of 80% to 91.6%.

12. The method of claim 1, wherein a total content of the impurities including Al, K and Cu is 300 ppb or greater in the phosphoric acid raw material.

13. The method of claim 1, wherein the phosphoric acid obtained using the method includes Al, K and Cu each in an amount of 1 ppb or less.
